(19) United States
(12) Patent Application Publication
(10) Pub. No.: US 2006/0055777 A1
(43) Pub. Date: Mar. 16, 2006

(54) Surveillance camera system

(75) Inventors: Tomokazu Ito, Toyoake-shi (JP); Takumi Miyata, Nagoya-shi (JP)

Correspondence Address: KODA & ANDROLIA, 2029 CENTURY PARK EAST, SUITE 1140, LOS ANGELES, CA, 90067, US

(73) Assignee: Elmo Co., Ltd.

(21) Appl. No.: 11/171,166

(22) Filed: Jun. 30, 2005

(30) Foreign Application Priority Data
Sep. 15, 2004 (JP) 2004-268363

(51) Int. Cl. H04N 7/18; H04N 9/47

(52) U.S. Cl. 348/143

(57) ABSTRACT

A surveillance camera system includes a mask image setting unit which sets a mask image at a predetermined location on an image displayed on a monitor, a mask coordinate storing unit which stores data of a coordinate of the set mask image on a mask plane coordinate plot of the set mask image, an inverted mask coordinate storing unit which calculates and stores data of a coordinate of the mask image inverted by an inversion pan range of ±180 degrees relative to the coordinate on the mask plane coordinate plot and data of a coordinate of the mask image inverted by an inversion tilt range of ±180 degrees relative to the coordinate on the mask plane coordinate plot, a determining unit which determines whether the mask image or the inverted mask image is present within the view angle of the surveillance camera, based on detected pan and tilt ranges and a detected zoom factor, and an image display control unit which controls the surveillance camera so that the mask image or inverted mask image is superposed on the pickup image to be displayed when the mask image or the inverted mask image is present within the view angle of the surveillance camera, based on determination by the determining unit.

### BACKGROUND OF THE INVENTION

1. Field of the Invention

This invention relates to surveillance camera systems.

2. Description of the Related Art

Surveillance camera systems have conventionally been provided in which both pan range and tilt range are not less than 180 degrees and which include an image inverting device. In these surveillance camera systems, an image obtained at a reference position where both pan and tilt ranges are at 0 degrees is the same as an image obtained at a position obtained by panning the camera 180 degrees and tilting the camera 180 degrees and further obtained by inverting the image upside down and symmetrizing the image bilaterally.

However, on an absolute coordinate in a case where a mask image is set, the aforesaid reference position differs from the position obtained by panning the camera 180 degrees and tilting the camera 180 degrees. Accordingly, mask images need to be set on absolute coordinates at the respective two positions with respect to the same object.

### SUMMARY OF THE INVENTION

Therefore, an object of the present invention is to provide a surveillance camera system in which a mask image can automatically be set so that the same image is obtained by inverting the image upside down and symmetrizing the image bilaterally and the mask image can be superposed.

The present invention provides a surveillance camera system in which an image obtained by a surveillance camera controlled to be panned and tilted and zoomed is displayed on a monitor and the image is inverted upside down and symmetrized bilaterally when a tilt range is larger than a reference position by a predetermined angle or more and a mask image can be superposed on any part within a view angle of the surveillance camera, the system comprising a pan range detector detecting a pan range of the surveillance camera, a tilt range detector detecting a tilt range of the surveillance camera, a zoom factor detector detecting a zoom factor of the surveillance camera, a mask image setting unit which sets a mask image at a predetermined location on an image displayed on the monitor, a mask coordinate storing unit which stores data of a coordinate of the set mask image on a mask plane coordinate plot of the set mask image, an inverted mask coordinate storing unit which calculates and stores data of a coordinate of the mask image inverted by an inversion pan range of ±180 degrees relative to the coordinate on the mask plane coordinate plot and data of a coordinate of the mask image inverted by an inversion tilt range of ±180 degrees relative to the coordinate on the mask plane coordinate plot, a determining unit which determines whether the mask image or the inverted mask image is present within the view angle of the surveillance camera, based on the detected pan and tilt ranges and the detected zoom factor, and an image display control unit which controls the surveillance camera so that the mask image or inverted mask image is superposed on the image thereby to be displayed when the mask image or the inverted mask image is present within the view angle of the surveillance camera, based on determination by the determining unit.

When a mask image is set at the predetermined location on an image displayed on the monitor by the mask image setting unit, data of a coordinate of the set mask image on the mask plane coordinate plot is stored by the mask coordinate storing unit. The inverted mask coordinate storing unit then obtains by calculation a coordinate of the mask image inverted by an inversion pan range of ±180 degrees relative to the coordinate on the mask plane coordinate plot. The inverted mask coordinate storing unit further obtains by calculation a coordinate of the mask image inverted by an inversion tilt range of ±180 degrees relative to the coordinate on the mask plane coordinate plot. The inverted mask coordinate storing unit stores data of the obtained coordinates. Based on the detected pan and tilt ranges and zoom factor, the determining unit determines whether the mask image or the inverted mask image is present within the view angle of the surveillance camera. When the determining unit determines that the mask image or the inverted mask image is present, the image display control unit controls the surveillance camera so that the mask image or inverted mask image is superposed on the image thereby to be displayed. Consequently, the mask image can automatically be set for a subject in a pickup image so that the same image is obtained by inverting the image upside down and symmetrizing the image bilaterally. Furthermore, the mask image can be superposed on the pickup image.

In another form, the surveillance camera system further comprises a color setting unit which sets any color of the mask image or inverted mask image when the mask image or inverted mask image is superposed on the image. Consequently, when any color is set for the mask image or inverted mask image so that the mask image or inverted mask image becomes distinct from the pickup image, the visibility of the mask image or inverted mask image can be improved.

### BRIEF DESCRIPTION OF THE DRAWINGS

Other objects, features and advantages of the present invention will become clear upon reviewing the following description of the embodiment with reference to the accompanying drawings, in which:

FIGS. 1A and 1B are block diagrams showing the arrangements of a surveillance camera system of one embodiment in accordance with the present invention;

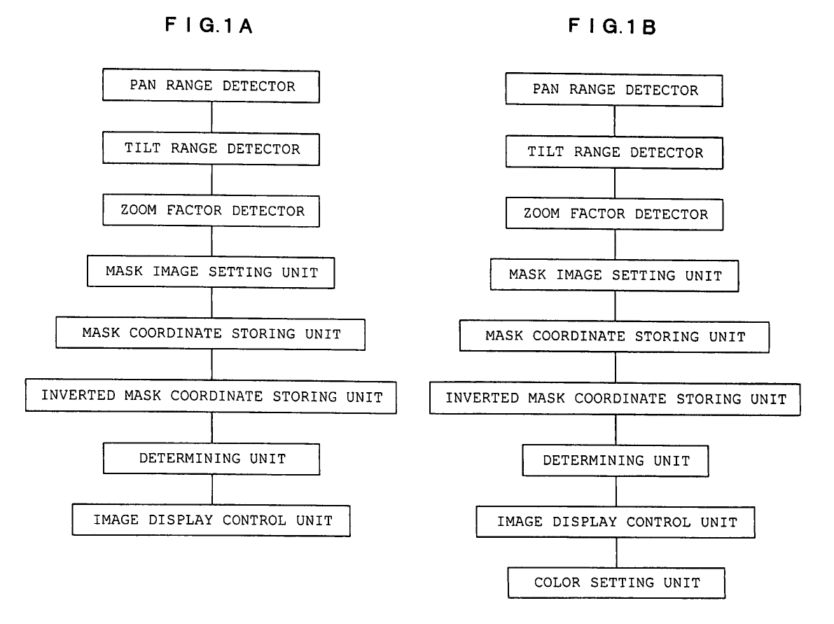

FIG. 2 is also a schematic block diagram of the surveillance camera system;

FIG. 3 shows panning and tilting of the surveillance camera;

FIG. 4 shows a mask plane coordinate plot; and

FIG. 5 shows an imaging manner of the surveillance camera.

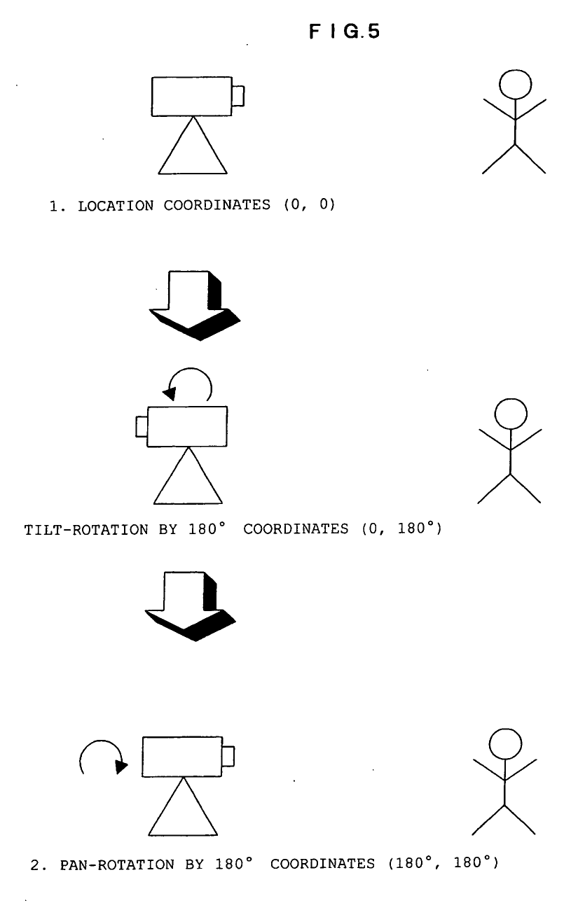

### DETAILED DESCRIPTION OF THE INVENTION

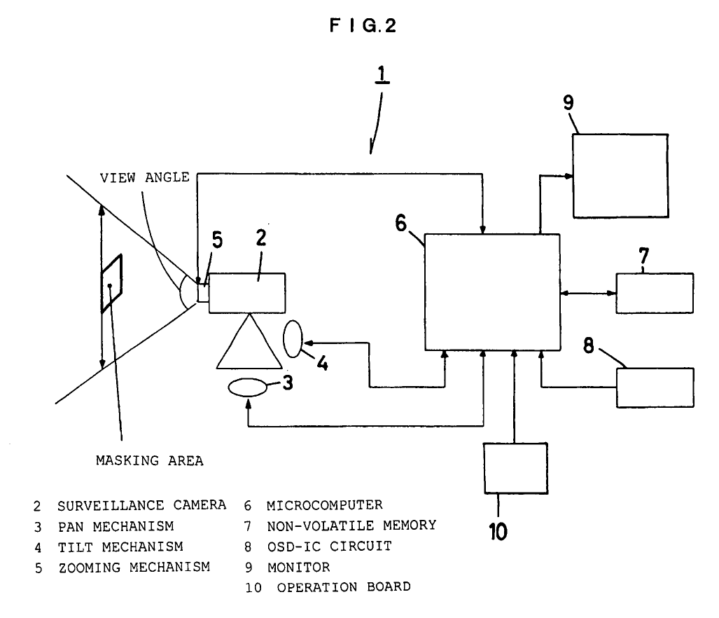

One embodiment of the present invention will be described with reference to the accompanying drawings. Referring first to FIG. 2, a schematic arrangement of the surveillance camera system 1 of the embodiment is shown. The surveillance camera system 1 includes a surveillance camera 2, a pan mechanism 3 including a stepping motor (not shown) for panning the surveillance camera 2, a tilt mechanism 4 also including a stepping motor (not shown) for tilting the surveillance camera 2, and a zooming mechanism 5. The surveillance camera 2 can be rotated 360 degrees in a panning direction by the pan mechanism 3, whereas the surveillance camera 2 can be rotated in the range from 0 to 180 degrees in a tilting direction by the tilt mechanism 4. The surveillance camera 2 includes a microcomputer 6, a non-volatile memory 7 and an on-screen display (OSD) IC circuit 8. A pickup image obtained by the surveillance camera 2 is converted to a composite video signal such as national television system committee (NTSC), whereby the pickup image is displayed on a monitor 9.

The microcomputer 6 delivers control signals to the pan and tilt mechanisms 3 and 4, based on a pan/tilt command supplied from an operation board 10 into the microcomputer 6. The OSD-IC circuit 8 superposes a set mask image on the pickup image of the surveillance camera 2. Furthermore, the microcomputer 6 controls the zooming mechanism 5 of the surveillance camera 2 to detect a zoom factor of a lens. Additionally, the microcomputer 6 detects a pan range and a tilt range both from a reference position of the surveillance camera 2 based on step angles of the respective stepping motors. As a result, what direction the surveillance camera 2 is directed can be understood. The operation board 10 is operated so that a mask image is superposed on the pickup image displayed on the monitor 9 by the OSD-IC circuit 8. A location and area of the mask image are designated. Consequently, data of the mask image is stored as a coordinate on a mask plane coordinate on a memory (not shown) of the microcomputer 6. The operation board 10 is further operated so that any color can be set for the mask image or an inverted mask image in superposition of the mask image or inverted mask image. The inverted mask image will be described later.

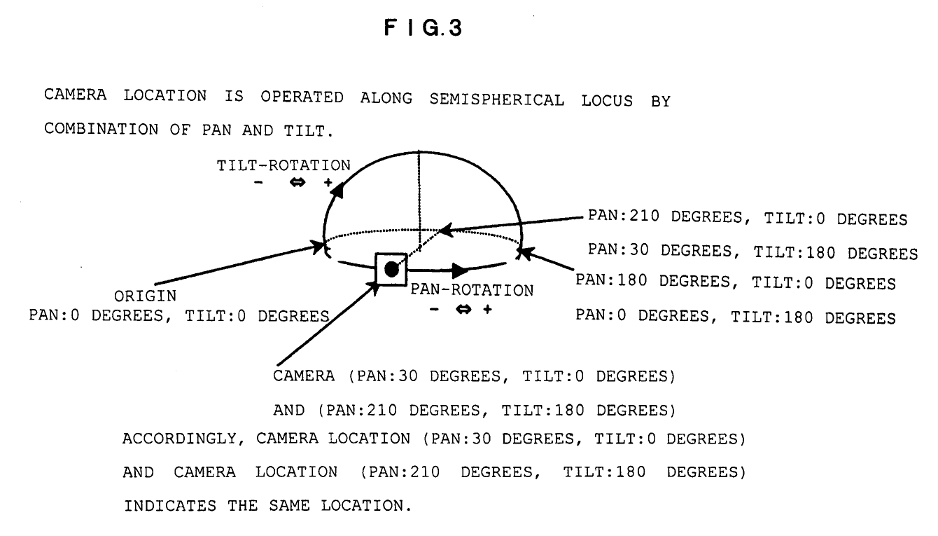

The camera location of the surveillance camera 2 moves in a hemispherical orbit as the result of combination of a pan operation and a tilt operation as shown in FIG. 3. For example, a camera location where a pan range is at 30 degrees and a tilt range is at 0 degrees coincides with another camera location where a pan range is at 210 degrees and a tilt range is at 180 degrees. Similarly, a camera location where a pan range is at 0 degrees and a tilt range is at 180 degrees coincides with a camera location where a pan range is at 180 degrees and a tilt range is at 0 degrees. Thus, there are at least two same camera locations depending upon the combination of pan and tilt ranges. Accordingly, a mask image needs to be set at every camera location.

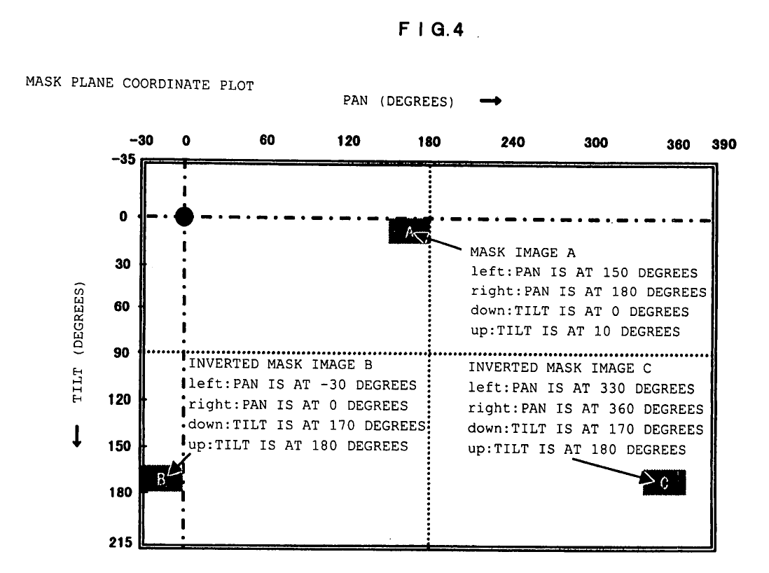

A mask image location stored by the memory is displayed on a mask plane coordinate plot in which the axis of abscissas denotes a pan range and the axis of ordinates denotes a tilt range. As shown in FIG. 4, a set mask image A is rectangular in shape, for example, and has a left side (“left”) represented by a coordinate in which the pan range is at 150 degrees, a right side (“right”) represented by a coordinate in which the pan range is at 180 degrees, a lower side (“down”) represented by a coordinate in which the tilt range is at 0 degrees and an upper side (“up”) in which the tilt range is at 10 degrees.

The mask image A set as described above has three inverted mask images which assume the same location as the mask image A. Coordinates of the three inverted mask images are obtained by calculation as follows. Inverted mask image B has a left side represented by a coordinate in which the pan range is at −30 degrees (150-180 degrees) and a right side represented by the pan range of 0 degrees (180−180 degrees). The inverted mask image B further has a lower side represented by the tilt range of 170 degrees (180−10 degrees, in which case the coordinate of the upper side of the mask image A is subtracted for the sake of the inverted display) and an upper side represented by the tilt range of 180 degrees (180−0 degrees, in which case the coordinate of the lower side of the mask image A is subtracted for the sake of the inverted display).

Furthermore, inverted mask image C has a coordinate of a left side represented by the pan range of 330 degrees (180 degrees are added to the coordinate of the left side of mask image A) and a coordinate of the right side represented by the pan range of 360 degrees (180−10 degrees, in which case, 180 degrees are added to the coordinate of the right side of mask image A). The inverted mask image C further has a coordinate of the lower side represented by the tilt range of 180 degrees (180−10, in which case the coordinate of the lower side of the mask image A is subtracted for the sake of inverted display) and a coordinate of the upper side represented by the tilt range of 180 degrees (180−0, in which case the coordinate of the lower side of the mask image A is subtracted for the sake of inverted display).

Accordingly, when the mask image A has been set on the plane coordinate plot arbitrarily, the coordinates of the inverted mask images B and C, which are locations diametrically opposed to the mask image A, can automatically be computed. Furthermore, data of the locations of the inverted mask images set on the basis of the obtained coordinates is stored by the memory. Although a set mask image usually has two inverted mask images, three inverted mask images are found when the pan range is at 0, 180 or 360 degrees, as described above.

When the operation board 10 is operated, the microcomputer 6 executes a predetermined control program to carry out the following process. Firstly, the pan mechanism and tilt mechanism are controlled so that the location of the surveillance camera 2 is transferred. The location of the displayed mask image is transferred according to changes in the pickup image with the transfer of the surveillance camera 2. The pan and tilt mechanisms are controlled so that the masking process is carried out for a predetermined subject without shift, and the pickup image is displayed on the monitor 9. The pickup image of the surveillance camera 2 is inverted upside down and symmetrized bilaterally when the tilt range is not less than 90 degrees. Accordingly, data of the pickup image read from the memory is once inverted upside down and symmetrized bilaterally, so that normally directed pickup image is displayed on the monitor 9. In this case, the microcomputer 6 determines whether the mask image A or the inverted mask image B or C is present within the view angle of the surveillance camera 2, based on the detected pan and tilt ranges, the detected zoom factor of the surveillance camera 2, data of the coordinates of the mask image A, inverted mask images B and C on the mask plane coordinate plot and the like. When determining that the mask image A or the inverted mask image B or C is present, the microcomputer 6 controls so that the mask image or inverted mask image is superposed on the pickup image on display.

According to the foregoing embodiment, the surveillance camera system 1 can automatically set the mask image for a subject in a pickup image so that the same image is obtained by inverting the image upside down and symmetrizing the image bilaterally. Furthermore, the surveillance camera system 1 can superpose the mask image on the pickup image.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A surveillance camera system in which an image obtained by a surveillance camera controlled to be panned and tilted and zoomed is displayed on a monitor and the image is inverted upside down and symmetrized bilaterally when a tilt range is larger than a reference position by a predetermined angle or more and a mask image can be superposed on any part within a view angle of the surveillance camera, the system comprising:
a pan range detector detecting a pan range of the surveillance camera;
a tilt range detector detecting a tilt range of the surveillance camera;
a zoom factor detector detecting a zoom factor of the surveillance camera;
a mask image setting unit which sets a mask image at a predetermined location on an image displayed on the monitor;
a mask coordinate storing unit which stores data of a coordinate of the set mask image on a mask plane coordinate plot of the set mask image;
an inverted mask coordinate storing unit which calculates and stores data of a coordinate of the mask image inverted by an inversion pan range of +180 degrees relative to the coordinate on the mask plane coordinate plot and data of a coordinate of the mask image inverted by an inversion tilt range of ±180 degrees relative to the coordinate on the mask plane coordinate plot;
a determining unit which determines whether the mask image or the inverted mask image is present within the view angle of the surveillance camera, based on the detected pan and tilt ranges and the detected zoom factor; and
an image display control unit which controls the surveillance camera so that the mask image or inverted mask image is superposed on the image picked up thereby to be displayed when the mask image or the inverted mask image is present within the view angle of the surveillance camera, based on determination by the determining unit.

2. The surveillance camera system according to claim 1, further comprising a color setting unit which sets any color of the mask image or inverted mask image when the mask image or inverted mask image is superposed on the image.
